(19) United States
(12) Patent Application Publication
(10) Pub. No.: US 2024/0234962 A9
(43) Pub. Date: Jul. 11, 2024

(54) CELL MODULE WITH RECHARGEABLE CELLS

(71) Applicant: Miba Battery Systems GmbH, Bad Leonfelden (AT)

(72) Inventors: Stefan GAIGG, Gmunden (AT); Georg HOCHREITER, Bad Leonfelden (AT)

(73) Assignee: Miba Battery Systems GmbH, Bad Leonfelden (AT)

(21) Appl. No.: 18/380,731

(22) Filed: Oct. 17, 2023

(30) Foreign Application Priority Data
Oct. 25, 2022 (AT) A50822/2022

(51) Int. Cl. H01M 50/507; H01M 10/613; H01M 10/6567; H01M 50/213

(52) U.S. Cl. CPC H01M 50/507; H01M 10/613; H01M 10/6567; H01M 50/213

(57) ABSTRACT

A cell module has rechargeable cells for storing electrical current, each cell having a positive pole and a negative pole, and a connecting structure, which has at least one first connecting element for connecting positive poles in an electrically conductive manner and at least one second connecting element for connecting negative poles in an electrically conductive manner. The first connecting element and the second connecting element are arranged on the same side of the cells connected thereto.

### CROSS REFERENCE TO RELATED APPLICATIONS

Applicant claims priority under 35 U.S.C. § 119 of Austrian Application No. A50822/2022 filed Oct. 25, 2023, the disclosure of which is incorporated by reference.

### BACKGROUND OF THE INVENTION

### 1. Field of the Invention

The invention relates to a cell module with a plurality of rechargeable cells for storing electrical current, each cell having a positive pole and a negative pole, and with a connecting structure, which has at least one first connecting element for connecting a plurality of positive poles in an electrically conductive manner and at least one second connecting element for connecting a plurality of negative poles in an electrically conductive manner.

The invention further relates to a cell pack comprising at least two cell modules.

The invention further relates to a method for producing a cell module with a plurality of rechargeable cells for storing electrical current, each cell having a positive pole and a negative pole, and with a connecting structure, which has at least one first connecting element and a second connecting element, wherein a plurality of positive poles are connected to one another in an electrically conductive manner by the first connecting element, and a plurality of negative poles are connected to one another in an electrically conductive manner by the second connecting element.

### 2. Description of the Related Art

Rechargeable batteries, also known as secondary cells or accumulators, have increasingly come into focus in the recent past, not least for environmental reasons. Such batteries are known from the prior art. AT 512 756 A1, for example, describes a battery pack for supplying electrical energy with a plurality of round cells in rows arranged offset from one another, the round cells having electrical poles and top and bottom plates projecting at least partially over the poles of the round cells, which are connected to the round cells for mechanical cohesion and have openings to air cool the round cells. The electrically conductive top and bottom plates are connected both electrically and by material bonding to the poles of the round cells.

AT 521 526 A1 describes a battery comprising a plurality of battery modules and at least one structural component, wherein a plurality of battery modules are arranged in a row on a flat side of a common structural component, wherein the battery modules each have a lower busbar and an upper busbar, between which there is a plurality of battery cells with uniform alignment of their poles, wherein one type of poles is connected to the lower busbar and the other type of poles is connected to the upper busbar, wherein each battery module has an upper cell holder, which is located above the battery cells and at least one lower cell pack holder, which is located below the lower busbars, wherein the following further applies to said row; their battery modules are each aligned with their lower busbar to the common structural component, all battery cells contained in the row face the structural component with only one type of pole, the battery modules of the row are connected in series in that, in each case, two consecutive battery modules have an electrical connection between a lower busbar of a first of these battery modules and an upper busbar of the second of these battery modules.

### SUMMARY OF THE INVENTION

The problem of the invention is to simplify cell contact in such batteries.

The problem of the invention is solved for the cell module mentioned at the beginning in that the first connecting element and the second connecting element are arranged on the same side of the cells connected thereto.

Furthermore, the problem of the invention is solved with the cell pack mentioned at the beginning, in which the two cell modules are configured according to the invention.

In addition, the problem of the invention is solved by the method mentioned at the beginning, which provides for the first connecting element and the second connecting element to be arranged on the same side of the cells connected thereto.

The advantage of this is that the cell module can be made more compact by arranging the cell connectors on only one side of the cells. Furthermore, this can also simplify the production of the cell module as all cell connectors can already be prepared in a first step and these can then be connected more easily to the cells, which avoids further manipulation for this purpose, such as turning the cell module.

To further simplify the components for the production of the cell module and the assembly of the cell module, according to an embodiment of the invention, it can be provided that the first and the second connecting element are configured as one piece with one another.

To improve short-circuit protection during production of the cell module, according to another embodiment of the invention, it can be provided that the positive poles of the cells are connected to the first connecting element in an electrically conductive manner in a first plane and the negative poles are connected to the second connecting element in an electrically conductive manner in a different second plane.

A further improvement in short-circuit protection can be achieved with another embodiment of the invention, according to which the first connecting element has contact portions, in which the positive poles are connected to the first connecting element in an electrically conductive manner, and intermediate portions, which connect the contact portions to one another, the intermediate portions being arranged in a different plane to the contact portions.

According to another embodiment of the invention, it can be provided that the first and the second connecting elements are arranged on a frame element. This simplifies the arrangement of the connecting elements on the cells.

According to an embodiment, it can be provided that the frame element has support surfaces for the first and second connecting elements, thus achieving improved positioning of the connecting elements.

According to an embodiment, it is advantageous for the frame element to be part of a cell holder, in which the cells are at least partially arranged such that the frame element can remain on the cell module and thus also be available during operation to position the connecting elements. This can prevent changes in shape due to thermal loads on the cell module, for example.

According to a further embodiment of the invention, for better mechanical protection of the cells, it can be provided that at least 95% of the end faces of the cells is covered by the frame element and the first and second connecting elements in a plan view of the positive poles and the negative poles. This means that no further components are required for this purpose, thereby simplifying the structural configuration of the cell module.

According to an embodiment of the cell pack, it can be provided that the first and second connecting elements of the first cell module and the first and second connecting elements of the second cell module are arranged between the cells of the first and second cell module, thereby structurally simplifying the cell contact of adjacent cell modules.

According to an embodiment of the invention, it can be provided that a temperature control element is arranged between the cells of the first and second cell module for this purpose. This enables four-pole arrangements with only one temperature control element.

To achieve the aforementioned advantages, according to one embodiment of the method, it can be provided that the frame element is configured as part of a cell holder, that the cell holder equipped with the connecting elements is pushed onto the cells and that the first connecting element is subsequently connected to the positive poles in an electrically conductive manner and the second connecting element is connected to the negative poles of a plurality of rechargeable cells in an electrically conductive manner.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a cell module in plan view;

FIG. 2 shows the cell module according to FIG. 1 in side view;

FIG. 3 shows a cell of the cell module in oblique view;

FIG. 4 shows connecting elements for electrically connecting cells of the cell module;

FIG. 5 shows a section of a cell module in oblique view from above;

FIG. 6 shows a side view of a section of a cell module;

FIG. 7 shows a cell holder in oblique view;

FIG. 8 shows the cell holder according to FIG. 7 with attached connecting elements in oblique view;

FIG. 9 shows a plan view of a section of a cell module without connecting elements;

FIG. 10 shows the section of the cell module according to FIG. 9 in plan view with connecting elements;

FIG. 11 shows an embodiment of a cell pack in side view; and

FIG. 12 shows a section from another embodiment of a cell pack in side view.

### DETAILED DESCRIPTION OF PREFERRED EMBODIMENTS

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. refer to the figure directly described and shown, and these indications of position can be applied in the same way to the new position should the position change.

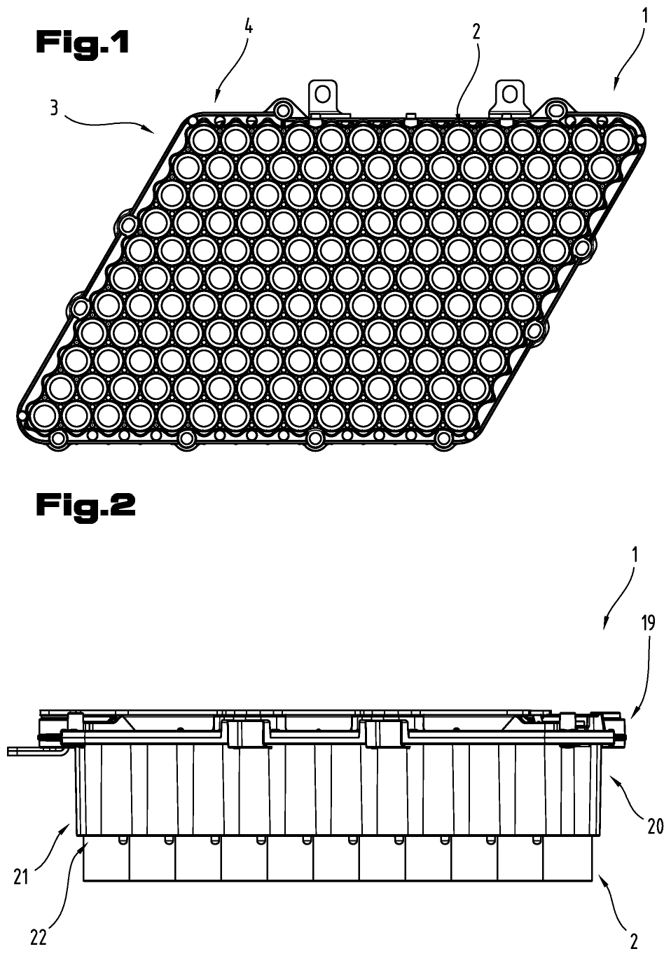

FIGS. 1 and 2 show different views of a cell module 1. The cell module 1 comprises a plurality of cells 2. The cells 2 are used to repeatedly store electrical energy. The cells 2 can also be referred to as secondary cells or accumulator cells. The cells 2 are what are known as lithium-ion accumulator cells, for example, in particular with lithium-nickel-manganese-cobalt-oxide chemistry (NMC) or lithium-nickel-cobalt-aluminum-oxide chemistry (NCA) or with lithium-iron-phosphate chemistry (LFP). The cells 2 are preferably configured as round cells (cylindrical cells). However, these can also be another shape, for example prismatic.

It should be noted that the geometric configuration of the cell module 1 shown in FIGS. 1 and 2 as well as the number of cells 2 shown specifically should not be seen as limiting the invention or the cell module 1. The cells 2 are arranged in rows 3 and columns 4, wherein preferably directly successive rows 3 are arranged offset from one another so that the cells 2 of a row 3 can be arranged partially in gaps between the cells 2 of the adjacent rows 3. However, the rows 2 can also not be offset. Furthermore, several rows 3 and several columns 4 per cell module 1 are preferably present. However, the cell module 1 can also have only one row 3 of cells 2 or one column 4 of cells 2. Preferably, all rows 3 and/or all columns 4 each have the same number of cells 2.

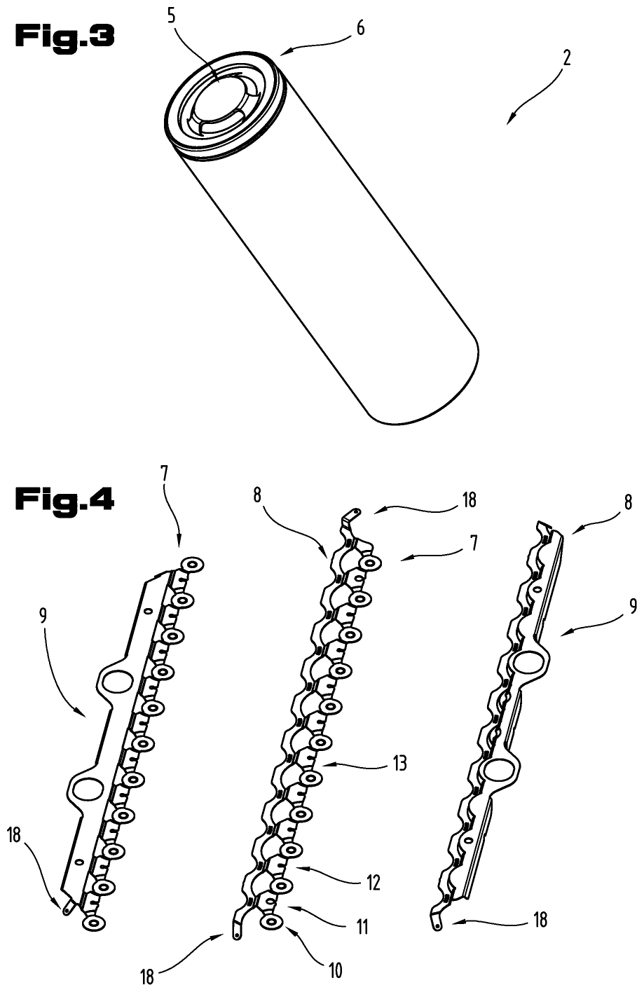

As is clearer from FIG. 3, each cell 2 has a positive pole 5 or generally a first pole (hereinafter referred to only as positive pole 5) and a negative pole 6 or generally a second pole (hereinafter referred to only as negative pole 6). The positive pole 5 and the negative pole 6 are arranged on the same side of the cells 2. In the embodiment of the cell 2 shown, the positive pole 5 is arranged centrally on the cell 2 and projects. The negative pole 6 is annularly configured and is arranged radially further outward than the positive pole 5.

Preferably, all cells 2 are arranged with the same alignment with respect to their poles in the cell module 1.

Since a plurality of cells 2 are arranged in the cell module 1, the cell module has a connecting structure to simplify contacting of the cell poles. This has at least one first connecting element 7 for connecting a plurality of positive poles 5 in an electrically conductive manner and at least one second connecting element 8 for connecting a plurality of negative poles 6 in an electrically conductive manner as illustrated by a preferred embodiment in FIG. 4. In this embodiment, the two connecting elements are formed with one another as one piece, thus forming only one common connecting structure element. However, it is possible for the first and second connecting elements 7, 8 to be arranged separately from one another, and for an electrical connection to be established separately.

By means of the one-piece configuration embodiment of the connecting elements 7, 8, the positive poles 5 are each connected to the negative poles 6 of two directly adjacent columns 4 of cells 2 in an electrically conductive manner.

In general, this is the first connecting element 7 and the second connecting element 8 that are arranged on the same side of the cells 2 connected thereto, i.e. on that side upon which the poles of the cells 2 are also arranged.

Furthermore, the first connecting element 7 and/or the second connecting element 8 preferably have a sequence of recurring units in their longitudinal direction, as can be seen from FIG. 4.

It is further preferred for the first connecting element 7 and/or the second connecting element 8 to extend continuously over the entire number of cells 2 of a column 4 so that, with the exception of the peripheral columns 4, a first and a second connecting element 7, 8 is arranged on cells 2, per column 4.

The two peripheral columns 4 are preferably each provided with their own connecting elements 7, 8, which only have one first connecting element 7 for the positive poles 5 or only one second connecting element 8 for the negative poles 6. In addition, these peripheral connecting elements 7, 8 can also have attachment portions 9 for a further cell module 1 or for the electrical integration of the cell module 1 into a circuit.

The first connecting element 7 and the second connecting element 8 are made of an electrically conductive material, in particular of a metal or a metal alloy or a plated material of metals only mechanically interconnected, such as aluminum, copper, nickel or alloys of or with these metals. The first connecting element 7 and the second connecting element 8 can be configured as a single layer or as a laminate with intermediate layers or electrical insulator layers, for example. The electrically conductive part of the first connecting element 7 and of the second connecting element 8, or the first and second connecting elements 7, 8, can have a layer thickness between 0.1 mm to 0.5 mm. Although it is possible to increase the layer thickness to above 0.5 mm, this may impair the material bond connection to the cells.

The first connecting element 7 and/or the second connecting element 8 can be produced from a metal sheet or a metal plate, e.g. from a sheet metal strip. The preferred shape described in more detail below can be produced by forming or by cutting processes, such as punching. However, other configurations and production methods are also possible.

In the preferred embodiment of the invention, all cells 2 of a column 4 are each connected to the first connecting element 7 and to the second connecting element 8 as already described above. However, the first connecting element 7 and/or the second connecting element 8 can also have other dimensions, so that more or fewer cells 2 are covered, even if this is not preferred.

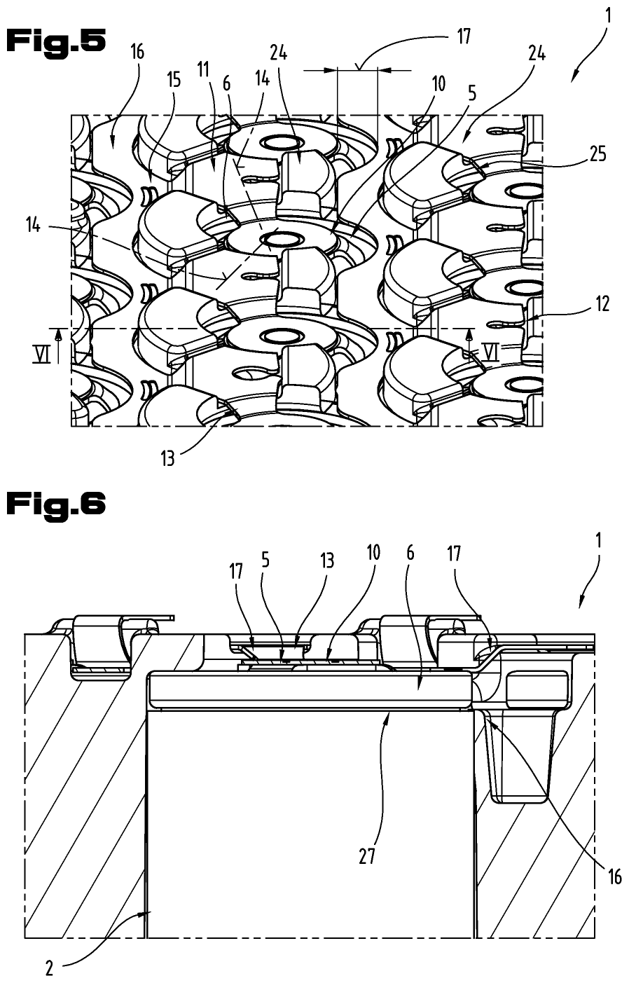

The first connecting element 7 can have a sequence of first contact portions 10 and intermediate portions 11. The first connecting element 7 is connected to the cells 2, i.e. the positive poles 5, in an electrically conductive manner in the contact portions 10 as can be seen in FIGS. 5 and 6, which each show sections of a cell module 1. This connection can be established by material bonding; by laser welding etc., for example. The material bonding surfaces, i.e. that surface of the contact portions connected by material bonding to the positive pole 5, can be configured as spiral-shaped, circular, punctiform or annular (as shown in FIGS. 5 and 6). The proportion of the respective material bonding surface on the corresponding surface of the contact portion can be between 5% and 40%; for example between 5% and 20%. Preferably, the material bonding surface of the positive pole 5 is larger than that of the negative pole 6 per cell 2, for example between 2 times and 5 times larger.

The contact portions 10 are preferably configured as cylindrical with circular end faces. In this case, the end faces can be between 50% and 100%, for example between 80% and 100%, in size of the area of the associated positive pole 5 abutting against the respective contact portion 10.

The intermediate portions 11 connect the contact portions 10 to one another. The intermediate portions 11 can each have a recess 12, which are configured in particular as openings through the intermediate portions 11. This thereby offers tolerance compensation during forming since these recesses 12 can widen during forming. This keeps the semi-finished product dimensionally stable, meaning it can be produced without expensive, complex forming tools, such as biased spring cushions, etc. These can begin at an end face of the intermediate portions 11 so that these recesses 12 are open, i.e. not completely closed. Furthermore, the recesses 12 can have a widening cross section, whereas the omega-shaped cross section of the recesses 12 shown in the figures is to be understood only as an example.

The intermediate portions 11 can be arranged in a plane with the contact portions 12 such that the intermediate portions 11 directly adjoin the contact portions. However, according to a preferred embodiment of the first connecting elements 7, it can be provided that the intermediate portions 11 are arranged in a different plane to the contact portions 10, in particular in a plane arranged further away from the positive poles 5 as can be seen from FIG. 5, for example. In other words, in this embodiment, the contact portions 10 are arranged lower in the cell module 1 than the intermediate portions 11.

Preferably, all contact portions 10 of a first connecting element 7 or a cell module 1 are arranged in a first common plane and all intermediate portions 11 of a first connecting element 7 or a cell module 1 in a second common plane.

In order to realize this arrangement in different planes, connecting portions 13 are arranged or configured between the contact portions 10 and the intermediate portions 11. The connecting portions 13 are arranged at an angle to the contact portions 10 and the intermediate portions 11 that is not equal to 0° and is preferably greater than or equal to 90°. The connecting portions 13 preferably extend obliquely upwards (as viewed from the plane of the contact portions 10).

It is further preferred for only one connecting portion 13 to be configured respectively between a contact portion 10 and an adjoining intermediate portion 11 so that the contact portions 10 (if necessary with the exception of the two peripheral contact portions 10 shown in FIG. 4 at the beginning and at the end of the first connecting element 7) are respectively connected to two connecting portions 13 with two intermediate portions 11. However, more than one connecting portion 13 can also be arranged between a contact portion 10 and an intermediate portion 11; for example two or three.

As a result of the arrangement of the connecting portions 13, the first connecting element 7 has a mountain-valley profile.

It is further preferable for the contact portions 10 to be arranged such that the connecting portions do not lie on a line, but that a zigzag pattern is formed (as seen in a plan view of the first connecting element 7). The longitudinal central axes 14 extend through the connecting portion 13 thus preferably at an angle to one another not equal to 180°. For single-cell protection, a web to the positive pole 5 can also be reduced to a width between 0.8 mm and 1.5 mm, for example to 1 mm.

The second connecting element 8 also has contact portions 15 and intermediate portions 16. In the contact portions 15, the second connecting element 8 is connected to the negative poles 6 of the cells 2 in particular by material bonding, preferably by laser welding. The intermediate portions 16 serve inter alia to connect the contact portions 15 to one another to form the second connecting element 8.

Observed in plan view, the second connecting element 8 can have an at least approximately serpentine-shaped extension. As can be seen in particular from FIG. 5, this results in the contact portions 15 of the second connecting element 8 being arranged at a greater distance from the contact portions 10 of the first connecting element 7. A distance 17 between the contact portions 10 and the contact portions 15 of two first and second connecting elements 7, 8 arranged directly adjacent to one another can be at least 1 mm to at least 5 mm, for example between 2 mm and 4 mm.

Due to the arrangement of the cells 2 in the cell module 1, the contact portions 10 and the contact portions 15 of two first and second connecting elements 7, 8 arranged directly adjacent to one another can be arranged opposite one another. Insofar as the first and second connecting elements 7, 8 are formed with one another as one piece to form the aforementioned connecting structural element, the contact portions 10 of the first connecting element 7 lie opposite the intermediate portions 16 of the second connecting element 8 in the connecting structural element, and the contact portions 15 of the second connecting element 8 lie opposite the intermediate portions 11 of the first connecting element 7. The connection of the first connecting element 7 with the second connecting element 8 to the connecting structure element is preferably formed between the contact portions 15 of the second connecting element 8 and the intermediate portions 11 of the first connecting element 7 as can be seen from FIG. 5, for example. If the intermediate portions 11 of the first connecting element 7 are on a higher plane as described above, obliquely extending connecting portions 17 can also be formed between the first and second connecting elements 7, 8. With regard to these connecting portions 17, reference is made to the passages concerning the connecting portions 13 of the first connecting element 7, which can also be applied to the connecting portions 17 between the first and second connecting elements 7, 8.

The second connecting element 8 can be configured to be planar or have a mountain-valley profile as described above with respect to the first connecting element 7. Thus, the contact portions 15 and the intermediate portions 16 can be arranged in one plane or in different planes. In this regard, reference is also made to the corresponding passages regarding the planes of the first connecting element 7.

As can be seen in FIG. 4, the second connecting element can have terminal lugs 18. The lugs 18 can be used to parallelize the cell modules 1. After connection, minimal BMS equalizing currents flow across these lugs 18 and ensure a homogeneous voltage curve within the cell modules 1, thereby enabling operation of the (two) cell modules 1 with only one BMS module. Furthermore, the BMS (battery management system) can be wired to these lugs 18 and thus carry out voltage tapping.

According to an embodiment of the cell module 1, it can be provided that the positive poles 5 of the cells 2 are connected to the first connecting element 7 in an electrically conductive manner in a first plane and the negative poles 6 are connected to the second connecting element 8 in an electrically conductive manner in a different second plane. This embodiment can also be seen in FIG. 5. It can be provided in particular that the first plane of the electrically conductive connection of the positive poles 5 in the cell module 1 is formed above the second plane of the electrically conductive connection of the negative poles 6 so that the positive poles 5 project beyond the negative poles 6 in the direction of the connecting elements 7, 8.

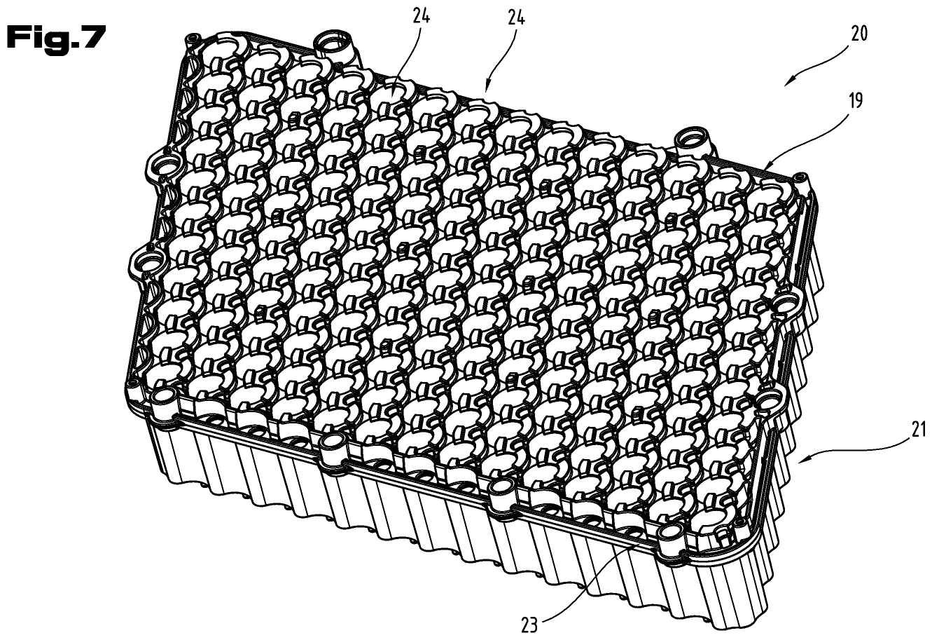

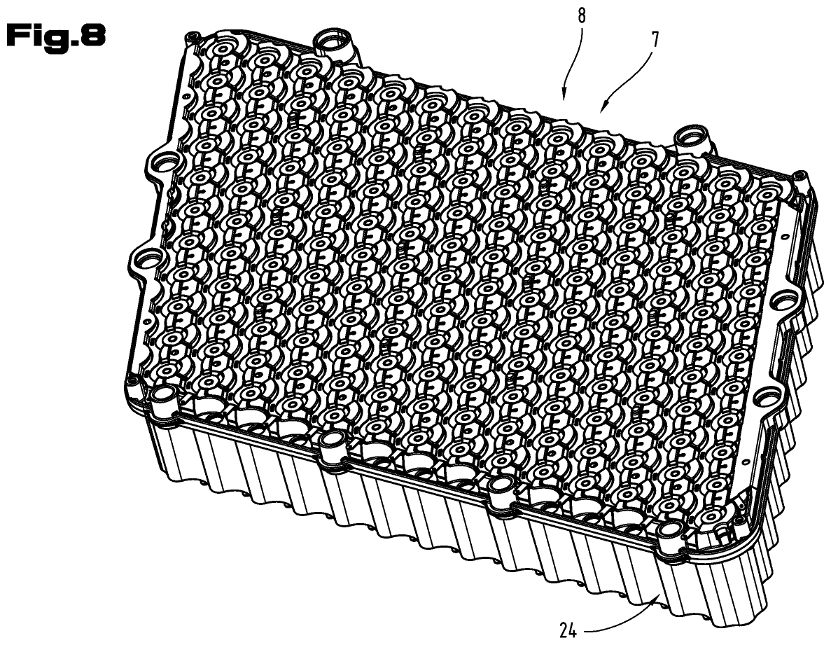

For producing the cell module 1, it has proven advantageous for the first and second connecting elements 7, 8 to be placed on a frame element 19 so that they are arranged on the frame element 19 in the cell module 1. The frame element 19 can be configured as a simple frame. In the preferred embodiment of the cell module also shown in FIGS. 7 and 8, the frame element 19 is part of a cell holder 20. For this purpose, the cell holder 20 has a cell-receiving element 21, in which recesses 22 are arranged or configured to at least partially receive the cells 2 as can be seen in FIG. 2. In the present embodiment, the recesses 22 in the cell receiving element 21 are configured as cylindrical openings. In general, however, the shape of the recesses 22 may depend on the respective shape of the cells 2. The cells 2 in the cell module 1 are positioned in the correct location with respect to one another or are held at a distance from one another by the cell holder 20.

Preferably, the frame element 19 and the cell receiving element 21 are configured as a one-piece cell holder 20. The cell holder 20 can be formed as an injection-molded part made of a plastic, for example.

The frame element 19 can be formed by a simple, circumferentially closed frame, upon which the first and second connecting elements 7, 8 are supported only in the end regions. In the preferred embodiment, however, the frame element 19 (as part of the cell holder 20) additionally has support surfaces 23, upon which the first and second connecting elements 7, 8 can also be supported in the region of the cells 2. These support surfaces 23 can be formed by form elements of the frame element 19, for example, which are arranged or formed in the frame element 19 as an extension of the side walls 24 (directly) delimiting the recesses 22 in the cell receiving element 21. As an individual recess 22 is preferably provided in the cell holder 20 for each cell 2, support surfaces 23 for the first and second connecting elements 7, 8 are accordingly preferably formed between each cell 2.

According to an embodiment, it can be provided that the frame element 19 has projections 24 protruding beyond the support surfaces 23. Reference is also made to FIG. 5 for these. The projections 24 can be arranged between the first and second connecting elements 7, 8 so as to protrude beyond these. Preferably, these are arranged on the support surfaces 23. The projections 24 can achieve better positioning of the first and second connecting elements 7, 8 on the frame element 19.

As can be particularly clearly seen in FIG. 5, when the first and second connecting elements 7, 8 are configured as one piece to said connecting structure element, it can be provided that projections 24 penetrate the connecting structure element and, for this purpose, corresponding openings 25 can be formed in the connecting structure element between the first and second connecting elements 7, 8.

As can further be seen from FIG. 5, the shape of the projections 24 can be at least partially adapted to the shape of the first and/or second connecting elements 7, 8 respectively.

These embodiments offer a further improvement in positioning or, if required, a positional fixing of the first and second connecting elements to 7, 8 the frame element 19.

For a better hold or fix of the cells 2, projections 26 protruding in the direction of the cells 2 can be provided in the cell holder 20, which can engage or snap into recesses 27 in the cells 2, for example annular grooves in the cell casing, as shown in FIG. 5.

FIG. 8 shows the frame element 19 fully equipped with the first and second connecting elements 7, 8 or the fully equipped cell holder 20 respectively. The fully equipped cell holder 20 can subsequently be arranged on the prepared cells 2, which can be arranged, for example, in an assembly holder, and can be slipped over the cells 2 in particular. Subsequently, the first and second connecting elements 7, 8 are connected in an electrically conductive manner, for example welded, onto the positive poles 5 or negative poles 6 respectively. The first and second connecting elements 7, 8 can optionally be pressed against the cells for this purpose.

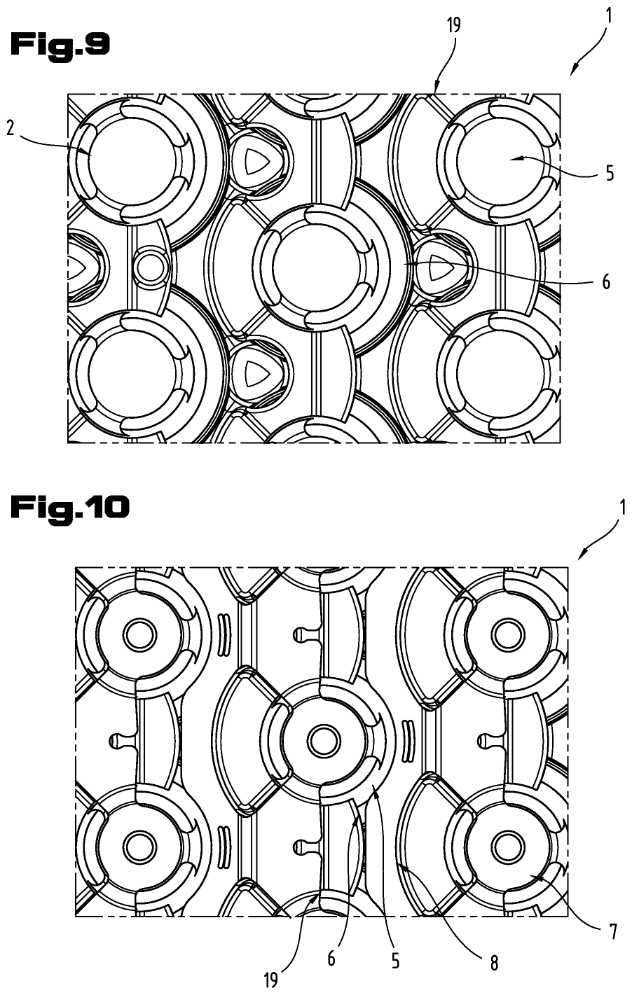

FIGS. 9 and 10 show a comparison of a section of a cell module 1 in plan view with and without first and second connecting elements 7, 8. As can be clearly seen, a large area of the cells 2, in particular their positive poles 5 and negative poles 6, is covered by the frame element 19 and the first and second connecting elements 7, 8. According to an embodiment of the cell module 1, it can be provided that, in a plan view of the positive poles 5 and the negative poles 6, at least 95% in particular at least 97% of the end faces of the cells 2 are covered by the frame element 19 and the first and second connecting elements 7, 8 for this purpose.

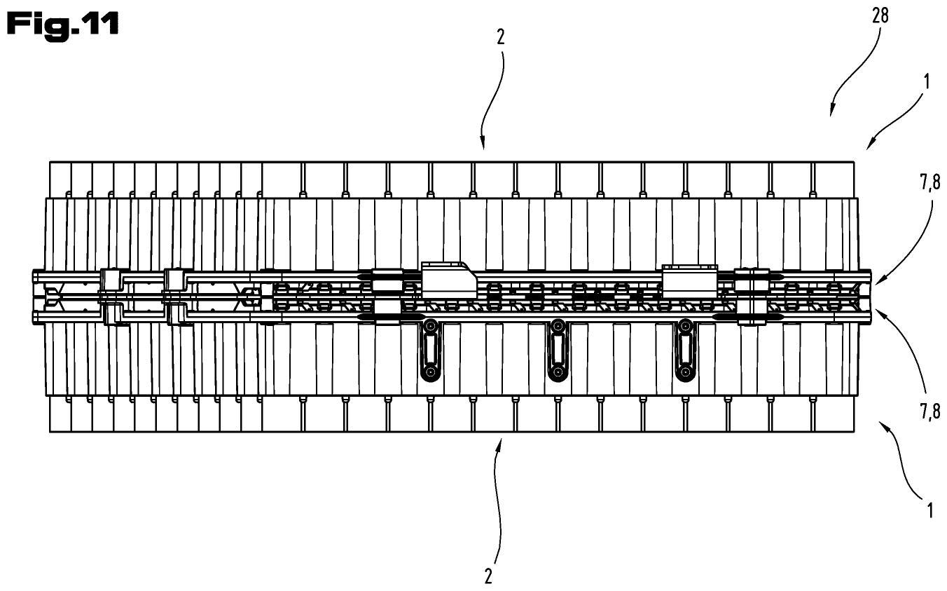

FIG. 11 shows an embodiment of a cell pack 28.

The cell pack 28 comprises or consists of two cell modules 1 in accordance with the invention. In the embodiment of the cell pack 28 shown, the two cell modules 1 are arranged such that the first and second connecting elements 7, 8 of the first cell module 1 and the first and second connecting elements 7, 8 of the second cell module 1 are arranged between the cells 2 of the first and second cell module 1. In other words, the poles of the cells 2 of the first cell module 1 therefore face the poles of the cells 2 of the second cell module 1.

However, it should be noted that the cell pack 28 can also have more than two cell modules 1 depending on its field of application. Furthermore, the cell modules can also all be arranged in one plane or in more than two planes.

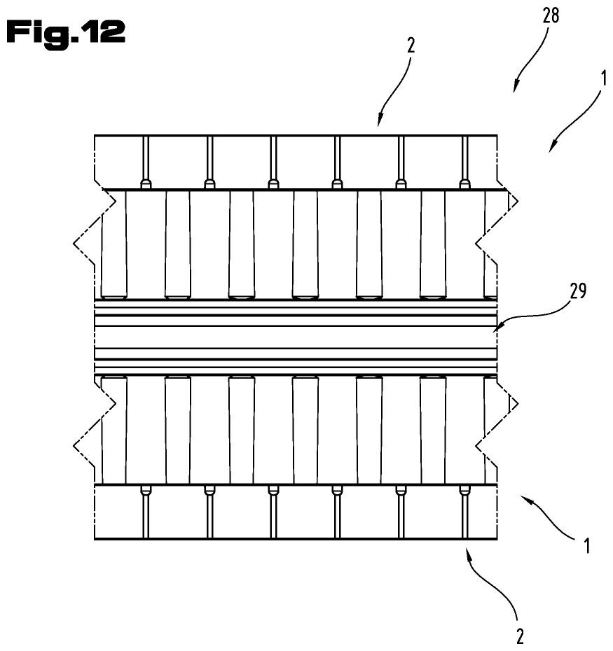

FIG. 12 shows a detail of a further embodiment of the cell pack 28. In this embodiment of the cell pack 28, provision is made for arranging a temperature control element 29, in particular a liquid cooler, between the cells 2 of the first and second cell module 1.

According to a further embodiment of the cell holder 1, provision can be made for individual cell protection in the form of overload protection for the cells 2. This can be achieved by reducing the thickness of the first and/or second connecting elements 7, 8 at least in the region of the connection to the positive poles 5 or negative poles 6. The thickness in these reduced regions can be between 0.5 mm and 2 mm for this purpose.

The embodiments show possible variants of the cell module 1 or the cell pack 28, however it is worth noting that it is also possible to combine the individual embodiments with one another.

Furthermore, a busbar in the form of one of the embodiments of the first and/or second connecting element or the connecting structural element described above and/or shown in the figures can constitute an independent invention in itself. Such a busbar has at least:
a sequence of contact portions 10 and intermediate portions 11 for the positive poles 5 and/or
a sequence of contact portions 15 and intermediate portions 16 for the negative poles 6.

For this purpose, the contact portions 10 are preferably arranged in a different plane to a plane of the intermediate portions 11 (mountain-valley arrangement). The contact portions 15 can also be arranged in a different plane to a plane of the intermediate portions 16 (mountain-valley arrangement). Furthermore, alternatively or additionally, it can be provided that the contact portions 10 are arranged in a different plane to a plane of the contact portions 15 (mountain-valley arrangement).

The frame element 19 or the cell holder 20 can also represent an independent invention. The frame element 19 or the cell holder 20 has at least the described support surfaces 23 for the first and second connecting elements 7, 8 and preferably also the described projections 24.

For the sake of good order and better understanding, it should finally be pointed out that that the structure of the cell module 1 or the cell pack 28 or elements thereof are not necessarily shown to scale.

Although only a few embodiments of the present invention have been shown and described, it is to be understood that many changes and modifications may be made thereunto without departing from the spirit and scope of the invention.

### LIST OF REFERENCE NUMERALS

1 Cell module
2 Cell
3 Row
4 Column
5 Positive pole
6 Negative pole
7 Connecting element
8 Connecting element
9 Attachment portion
10 Contact portion
11 Intermediate portion
12 Recess
13 Connecting portion
14 Longitudinal central axis
15 Contact portion
16 Intermediate portion
17 Connecting portion
18 Lug
19 Frame element
20 Cell holder
21 Cell receiving element
22 Recess
23 Support surface
24 Projection
25 Opening
26 Projection
27 Recess
28 Cell pack
29 Temperature control element

What is claimed is:

1. A cell module (1) with a plurality of rechargeable cells (2) for storing electrical current, each cell (2) having a positive pole (5) and a negative pole (6), and having a connecting structure, which has at least one first connecting element (7) for connecting a plurality of positive poles (5) in an electrically conductive manner and at least one second connecting element (8) for connecting a plurality of negative poles (6) in an electrically conductive manner, wherein the first connecting element (7) and the second connecting element (8) are arranged on the same side of the cells (2) connected thereto.

2. The cell module (1) according to claim 1, wherein the first and the second connecting elements (7, 8) are configured together as one piece.

3. The cell module (1) according claim 1, wherein the positive poles (5) of the cells (2) are connected to the first connecting element (7) in an electrically conductive manner in a first plane and the negative poles (6) are connected to the second connecting element (7) in an electrically conductive manner in a different second plane.

4. The cell module (1) according to claim 1, wherein the first connecting element (7) has contact portions (10), in which the positive poles (5) are connected to the first connecting element (7) in an electrically conductive manner, and intermediate portions (11), which connect the contact portions (10) to one another, the intermediate portions (11) being arranged in a different plane than the contact portions (10).

5. The cell module (1) according to claim 1, wherein the first and the second connecting elements (7, 8) are arranged on a frame element (19).

6. The cell module (1) according to claim 5, wherein the frame element (19) has support surfaces (23) for the first and the second connecting elements (7, 8).

7. The cell module (1) according to claim 5, wherein the frame element (19) is part of a cell holder (20), in which the cells (2) are at least partially arranged.

8. The cell module (1) according to claim 5, wherein at least 95% of the end faces of the cells (2) is covered by the frame element (19) and the first and second connecting elements (7, 8) in a plan view of the positive poles (5) and the negative poles (6).

9. A cell pack (28) comprising at least two cell modules (1), wherein the cell modules (1) are configured according to claim 1.

10. The cell pack (28) according to claim 9, wherein the first and second connecting elements (7, 8) of the first cell module (1) and the first and second connecting elements (7, 8) of the second cell module (1) are arranged between the cells (2) of the first and second cell module (1).

11. The cell pack (28) according to claim 10, wherein a temperature control element (29), in particular a liquid cooler, is arranged between the cells (2) of the first and second cell modules (1).

12. A method for producing a cell module (1) with a plurality of rechargeable cells (2) for storing electrical current, each cell (2) having a positive pole (5) and a negative pole (6), and having a connecting structure, which has at least one first connecting element (7) and one second connecting element (8), wherein a plurality of positive poles (5) are connected to one another by the first connecting element (7) in an electrically conductive manner and a plurality of negative poles (6) are connected to one another by the second connecting element (8) in an electrically conductive manner, wherein the first connecting element (7) and the second connecting element (8) are arranged on the same side of the cells (2) connected thereto.

13. The method according to claim 12, wherein the first and the second connecting elements (7, 8) are configured as one piece.

14. The method according to claim 12, wherein the first and the second connecting element (7, 8) are arranged on a frame element (19).

15. The method according to claim 14, wherein the frame element (19) is configured as part of a cell holder (20), wherein the cell holder (20) equipped with the connecting elements (7, 8) is pushed onto the cells (2) and wherein the first connecting element (7) is subsequently connected to the positive poles (5) in an electrically conductive manner and the second connecting element (8) is connected to the negative poles (6) of a plurality of rechargeable cells (2) in an electrically conductive manner.
